(19) United States
(12) Patent Application Publication
(10) Pub. No.: US 2012/0109573 A1
(43) Pub. Date: May 3, 2012

(54) METHOD OF DETERMINING A HEAT TRANSFER CONDITION FROM A RESISTANCE CHARACTERISTIC OF A SHAPE MEMORY ALLOY ELEMENT

(75) Inventors: Xiujie Gao, Troy, MI (US); Alan L. Browne, Grosse Pointe, MI (US); Nancy L. Johnson, Northville, MI (US); Guillermo A. Herrera, Winnetka, CA (US); Geoffrey P. McKnight, Los Angeles, CA (US); Lei Hao, Troy, MI (US); Andrew C. Keefe, Encino, CA (US); Christopher P. Henry, Thousand Oaks, CA (US)

(73) Assignee: GM GLOBAL TECHNOLOGY OPERATIONS, INC., Detroit, MI (US)

(21) Appl. No.: 12/938,683

(22) Filed: Nov. 3, 2010

(51) Int. Cl. G06F 15/00; F24J 3/00; G01N 25/00

(52) U.S. Cl. 702/136; 432/1

(57) ABSTRACT

A method of sensing an ambient heat transfer condition surrounding a shape memory alloy element includes heating the shape memory alloy element, sensing the resistance of the shape memory alloy element, and measuring the period of time taken to heat the shape memory alloy element to a pre-determined level of a resistance characteristic. The ambient heat transfer condition surrounding the shape memory alloy element is calculated by referencing a relationship between the period of time taken to heat the shape memory alloy to the pre-determined level of the resistance characteristic and the ambient heat transfer condition.

### TECHNICAL FIELD

The invention generally relates to a shape memory alloy element, and more specifically to a method of sensing an ambient heat transfer condition surrounding the shape memory alloy element, and a method of controlling the shape memory alloy element.

### BACKGROUND

A shape memory alloy element may be used to actuate a device. A controller may rely on an external sensor, which increases the complexity and cost of the device, to provide environmental information related to the shape memory alloy element. The controller relies on the environmental information in order to properly control the shape memory alloy element. An ambient heat transfer condition surrounding the shape memory alloy element, such as an ambient temperature, a humidity level, a fluid velocity, a heat transfer coefficient or a thermal conductivity, may affect heating of the shape memory alloy element. For example, the amount of power required to safely and efficiently actuate the shape memory alloy element at lower temperatures is different than the amount of power required to actuate the shape memory alloy at higher temperatures. If the power is kept constant for all ambient temperatures, the shape memory alloy element is at risk of overheating or partial actuation rendering the device unable to perform properly.

### SUMMARY

A method of sensing an ambient heat transfer condition is provided. The method includes heating a shape memory alloy element, and sensing a resistance of the shape memory alloy element over a period of time. The resistance of the shape memory alloy is sensed to determine a resistance characteristic in the shape memory alloy element. The method further includes measuring the period of time taken to heat the shape memory alloy element to the resistance characteristic, and calculating an ambient heat transfer condition adjacent the shape memory alloy element from the measured period of time taken to heat the shape memory alloy element to the resistance characteristic.

A method OF controlling a shape memory alloy element is also provided. The method includes heating the shape memory alloy element, and sensing a resistance of the shape memory alloy element over a period of time. The resistance of the shape memory alloy element is sensed to determine a resistance characteristic in the shape memory alloy element. The method further includes measuring the period of time taken to heat the shape memory alloy element to the resistance characteristic, calculating an ambient heat transfer condition adjacent the shape memory alloy element from the measured period of time taken to heat the shape memory alloy element to the resistance characteristic, and adjusting actuation of the shape memory alloy element based upon the calculated ambient heat transfer condition adjacent the shape memory alloy element.

Accordingly, the resistance of the shape memory alloy element is used to calculate the ambient heat transfer condition surrounding the shape memory alloy element, such as an ambient temperature, thereby augmenting or eliminating the need for external sensors for sensing the ambient heat transfer condition. Once the ambient heat transfer condition is calculated, a controller may adjust the actuation of the shape memory alloy element, for example, by increasing or decreasing a power input to the shape memory alloy element based on the ambient heat transfer condition adjacent the shape memory alloy element.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a flowchart showing a method of controlling a shape memory alloy element.

FIG. 2 is a graph showing the resistance of the shape memory alloy element and the first derivative of the resistance over time.

FIG. 3 is a table showing the relationship between the time taken to heat a shape memory alloy element to resistance characteristic vs. an ambient air temperature surrounding the shape memory alloy element.

### DETAILED DESCRIPTION

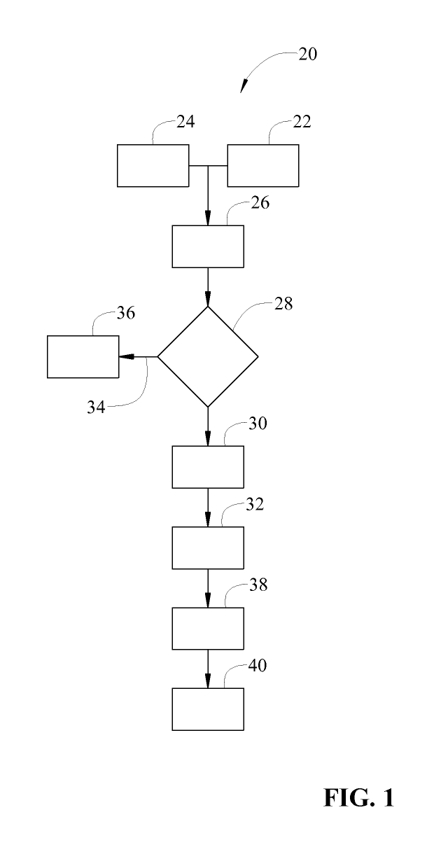

Referring to FIG. 1, a method of controlling a shape memory alloy element is generally shown at 20. The shape memory alloy element may be integrated into a device, including but not limited to a sensor device or an actuator device. The device may include a controller configured to control the device, and particularly the shape memory alloy element.

The controller may include, but is not limited to, a computer having a processor, memory, software, sensors, circuitry and any other components necessary for controlling the device and the shape memory alloy element. It should be appreciated that the method disclosed herein may be embodied as an algorithm operated by the controller or by analog circuitry.

The shape memory alloy element includes a shape memory alloy. Suitable shape memory alloys can exhibit a one-way shape memory effect, an intrinsic two-way effect, or an extrinsic two-way shape memory effect depending on the alloy composition and processing history. Two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic two-way shape memory effect are fabricated from a shape memory alloy composition that will automatically reform themselves upon removal of the cause for deviation.

The temperature at which the shape memory alloy remembers its high temperature form, referred to as the transformation temperature, can be adjusted by slight changes in the composition of the alloy and heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like. For example, a nickel-titanium based alloy is commercially available under the trademark NITINOL from Shape Memory Applications, Inc.

The controller may initiate an activation signal that causes the shape memory alloy to transform between the phases. The activation signal provided by the controller may include, but is not limited to, a heat signal or an an electrical signal, with the particular activation signal dependent on the materials and/or configuration of the shape memory alloy and/or the device. For example, the controller may direct an electrical current through the shape memory alloy element to heat the shape memory alloy element.

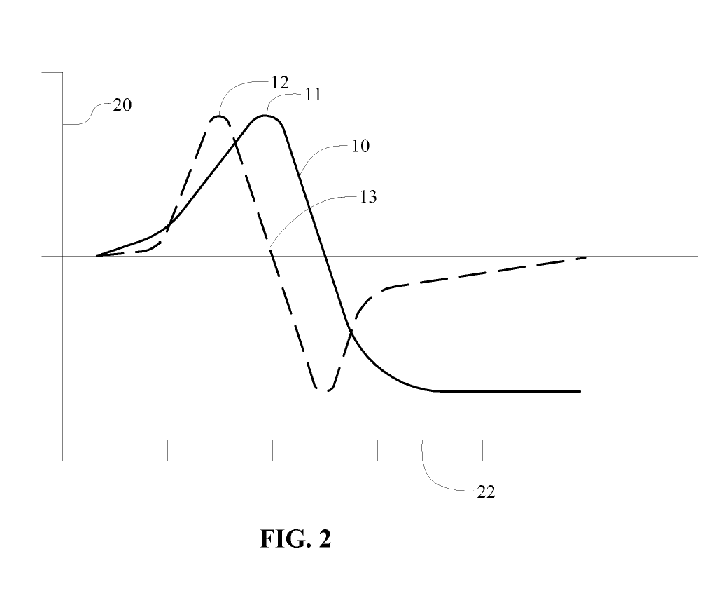

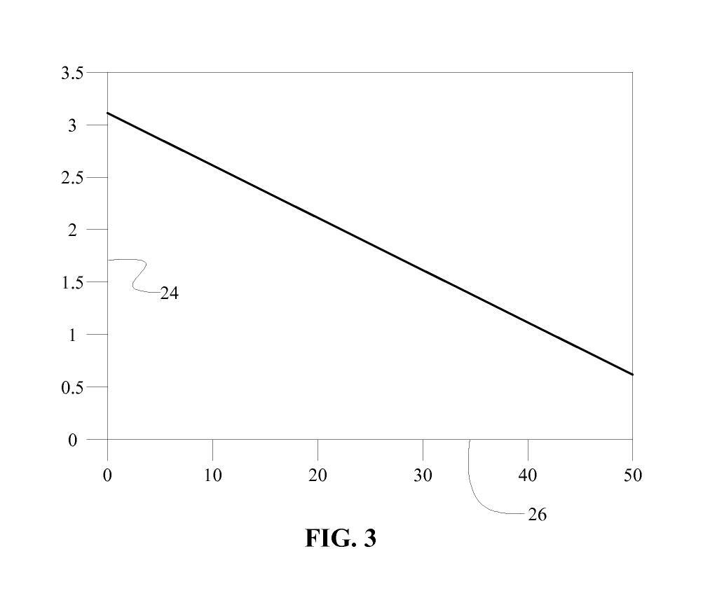

In the preferred embodiment, the resistance peak is the resistance characteristic used. Referring to FIG. 2, it has been found that the resistance of the shape memory alloy element peaks at the onset of a phase change. Within FIG. 2, the resistance 10 of the shape memory alloy element is shown along a vertical axis 20 and the time to reach the peak resistance 11 is shown along a horizontal axis 22. Accordingly, as the shape memory alloy element is heated, the resistance 10 increases to the peak resistance 11 at the onset of the phase change, and then decreases. Referring to FIG. 3, a correlation was found between the time taken to heat the shape memory alloy element to the resistance peak and the ambient temperature surrounding the shape memory alloy element. As shown in FIG. 3, for example, the period of time taken to heat the shape memory alloy element to the resistance peak is shown on a vertical axis 24 in seconds, and the ambient temperature surrounding the shape memory alloy element is shown on a horizontal axis 26 in degrees Celsius. As such, the ambient temperature surrounding the shape memory alloy element may be calculated from the period of time taken to heat the shape memory alloy element to the resistance peak, based on the relationship between the period of time taken to heat the shape memory alloy element to the resistance peak and the ambient temperature surrounding the shape memory alloy element. It should be appreciated that the relationship between the period of time taken to heat the shape memory alloy element to the resistance peak and the ambient temperature surrounding the shape memory alloy element is dependent upon the specific device and the shape memory alloy element utilized therein. Accordingly, FIG. 3 is merely an example relationship between the period of time to resistance peak and the ambient temperature. Other relationships between the time to the resistance peak may be non-linear.

Referring back to FIG. 1, the method of controlling the shape memory alloy element includes inputting energy into the shape memory alloy element to heat the shape memory alloy element, block 22, and initiating a timer simultaneously with initiation of heating the shape memory alloy element, block 24 and described in greater detail below. The inputted energy may be in the form of, but is not limited to, electrical energy. The controller may initiate an electrical current through the shape memory alloy element as part of an algorithm to sense an ambient heat transfer condition surrounding the shape memory alloy element. The heat transfer condition may include, but is not limited to, an ambient temperature, a heat transfer coefficient, a humidity level, a fluid velocity or a thermal conductivity. The shape memory alloy element heats as the electrical current is conducted through the shape memory alloy element. Preferably, the electrical current includes a continuous and constant, pre-determined value. However, the control algorithm may be modified to account for a fluctuating voltage via pulse width modulation or voltage regulation. In the case of pulse width modulation, the duty cycle is adjusted according to the voltage such that on average, a nearly constant current flow through the shape memory alloy element is maintained.

The method further includes sensing the resistance of the shape memory alloy element over a period of time, block 26. The controller tracks the sensed resistance to determine when the resistance reaches a pre-determined level of a resistance characteristic in the shape memory alloy element, block 28. Preferably, the pre-determined level of the resistance characteristic in the shape memory alloy element occurs just prior to a phase change. The pre-determined level of the resistance characteristic may include, but is not limited to, a peak resistance, an inflection point in the resistance, a resistance threshold crossing, or a pre-determined value or percentage thereof. Preferably, the pre-determined level of the resistance characteristic includes the peak resistance, which is the point at which the resistance of the shape memory alloy element stops increasing and begins decreasing.

Sensing the resistance of the shape memory alloy element may further include simultaneously measuring the current passing through the shape memory alloy element and the voltage drop across the shape memory alloy element in order to calculate the resistance. The resistance is calculated by dividing the measured voltage drop across the shape memory alloy element by the measured current passing through the shape memory alloy element at any instant in time.

Alternatively, sensing the resistance characteristic of the shape memory alloy element may include sensing an inflection point in the resistance and the time from initial heating of the shape memory alloy element to the inflection point. Referring to FIG. 2, the inflection point 12 is defined as the point where the derivative 13 reaches a maximum value. Upon heating, the derivative 13 of the resistance 10 of the shape memory alloy element will increase, followed by a decrease. The point where the derivative 13 changes from increasing to decreasing is the resistance inflection point 12. The heat transfer condition may be similarly determined from an equation or from a look up table using the time taken to reach the inflection point.

It is also contemplated that the resistance characteristic may be determined by integrating the energy input into the shape memory alloy element, and plotting the resistance of the shape memory alloy element against the energy input. This approach would require measuring the amount of energy input into the shape memory alloy element to heat the shape memory alloy element to the resistance characteristic. In this manner, voltage fluctuations in the sensing current may be ignored.

The method further includes measuring the period of time taken to heat the shape memory alloy element to the pre-determined level of the resistance characteristic. As noted above, measuring the period of time taken to heat the shape memory alloy element to the pre-determined level of the resistance characteristic may include initiating a timer simultaneously with initiation of heating the shape memory alloy element to define a start time, block 24. Accordingly, the start time begins or is initialized at the instant the controller initiates the heating of the shape memory alloy element. The time may include any suitable timer, including but not limited to an internal clock of the controller. The timer is stopped to define a stop time when the resistance of the shape memory alloy element reaches the resistance characteristic, block 30. The period of time taken to heat the shape memory alloy element to the pre-determined level of the resistance characteristic includes calculating the difference between the stop time and the start time, block 32. Accordingly, the numerical difference between the stop time and the start time equals the period of time taken to heat the shape memory alloy element to the pre-determined level of the resistance characteristic.

The method may further include defining a maximum period of time over which to sense the resistance of the shape memory alloy element. If the controller fails to identify the pre-determined level of the resistance characteristic in the maximum period of time, or the pre-determined level of the resistance characteristic is not achieved within the maximum period of time, indicated at 34, then the method may include signaling an error indicating that the pre-determined level of the resistance characteristic could not be determined, and stopping the ambient heat transfer condition sensing algorithm, block 36.

The method further includes calculating the ambient heat transfer condition adjacent the shape memory alloy element from the measured period of time taken to heat the shape memory alloy element to the pre-determined level of the resistance characteristic, block 38. Calculating the ambient heat transfer condition adjacent the shape memory alloy element may include solving an equation relating the measured period of time taken to heat the shape memory alloy element to the pre-determined level of the resistance characteristic to the ambient heat transfer condition of the shape memory alloy element. For example, an equation may be developed to solve the relationship shown in FIG. 3, whereby the time period to the pre-determined level of the resistance characteristic is input into the equation and the result of the equation is the ambient heat transfer condition surrounding the shape memory alloy element. Alternatively, calculating the ambient heat transfer condition adjacent the shape memory alloy element may include referencing a table relating the measured period of time taken to heat the shape memory alloy element to the pre-determined level of the resistance characteristic to the ambient heat transfer condition of the shape memory alloy element. Referencing the table relating the measured period of time taken to heat the shape memory alloy element to the pre-determined level of the resistance characteristic to the ambient heat transfer condition may include interpolating between values provided by the table to determine the value for the heat transfer condition. It should be appreciated that the ambient heat transfer condition adjacent the shape memory alloy element may be calculated based upon the period of time to the pre-determined level of the resistance characteristic in some other manner not described herein. Additionally, it is contemplated that the calculated ambient heat transfer condition may be calibrated and/or verified by referencing data from one or more external sensors.

The method may further include adjusting actuation of the shape memory alloy element based upon the calculated ambient heat transfer condition adjacent the shape memory alloy element, block 40. Adjusting actuation of the shape memory alloy element may include adjusting an actuation current for the shape memory alloy element, which may include but is not limited to adjusting a duty cycle of the shape memory alloy element or adjusting the level of an electrical current flowing through the shape memory alloy element. Adjusting actuation of the shape memory alloy element may further include adjusting a voltage drop across the shape memory alloy element. For example, because the time to heat the shape memory alloy element increases as the ambient temperature adjacent the shape memory alloy element decreases, and decreases as the ambient temperature adjacent the shape memory alloy element increases, the controller may adjust the activation signal, i.e., an activation current, to reflect the ambient temperature adjacent the shape memory alloy element. By adjusting the activation signal, the controller may more efficiently control the shape memory alloy element and avoid overheating the shape memory alloy element, or avoid only partially activating the shape memory alloy element.

The method may further include relating the calculated ambient heat transfer condition adjacent the shape memory alloy element to a heat transfer coefficient between the ambient and the shape memory alloy element. The heat transfer coefficient is the rate at which heat transfers between the shape memory alloy element and the ambient surrounding the shape memory alloy element. The shape memory alloy element must cool down between phase change cycles. The ambient temperature, and more specifically the heat transfer coefficient, effects the rate at which heat is dissipated from the shape memory alloy element. Accordingly, the controller may adjust the control signal based upon how fast the shape memory alloy element may cool, which is dependent upon the heat transfer coefficient. Therefore, adjusting actuation of the shape memory alloy element based upon the calculated ambient heat transfer condition adjacent the shape memory alloy element may include adjusting actuation of the shape memory alloy element based upon the heat transfer coefficient between the ambient and the shape memory alloy element.

While the best modes for carrying out the invention have been described in detail, those familiar with the art to which this invention relates will recognize various alternative designs and embodiments for practicing the invention within the scope of the appended claims.

1. A method of sensing an ambient heat transfer condition, the method comprising:
heating a shape memory alloy element;
sensing a resistance of the shape memory alloy element over a period of time;
measuring the period of time taken to heat the shape memory alloy element until a resistance characteristic reaches a pre-determined level; and
calculating an ambient heat transfer condition adjacent the shape memory alloy element from the measured period of time taken to heat the shape memory alloy element to the pre-determined level of the resistance characteristic.

2. A method as set forth in claim 1 wherein measuring the period of time taken to heat the shape memory alloy element until the resistance characteristic reaches the pre-determined level includes initiating a timer simultaneously with initiation of heating the shape memory alloy element to define a start time.

3. A method as set forth in claim 2 wherein measuring the period of time taken to heat the shape memory alloy element until the resistance characteristic reaches the pre-determined level includes stopping the timer to define a stop time when the resistance of the shape memory alloy element reaches the pre-determined level of the resistance characteristic.

4. A method as set forth in claim 3 wherein measuring the period of time taken to heat the shape memory alloy element until the resistance characteristic reaches the pre-determined level includes calculating the difference between the stop time and the start time to determine the period of time taken to heat the shape memory alloy element to the pre-determined level of the resistance characteristic.

5. A method as set forth in claim 1 further comprising defining a maximum period of time over which to sense the resistance of the shape memory alloy element.

6. A method as set forth in claim 5 further comprising signaling an error if the pre-determined level of the resistance characteristic is not achieved within the maximum period of time.

7. A method as set forth in claim 1 wherein heating the shape memory alloy element includes conducting an electrical current through the shape memory alloy element.

8. A method as set forth in claim 7 wherein conducting an electrical current through the shape memory alloy element is further defined as conducting an electrical current having a continuous pre-determined value through the shape memory alloy element.

9. A method as set forth in claim 7 further comprising modifying the electrical current to account for a fluctuating voltage by either a pulse width modulation of the electrical current or a voltage regulation of the electrical current.

10. A method as set forth in claim 1 wherein the ambient heat transfer condition includes one of an ambient temperature, a heat transfer coefficient, a humidity level, a fluid velocity and a thermal conductivity.

11. A method as set forth in claim 1 wherein the resistance characteristic includes one of a peak resistance, an inflection point in the resistance and a resistance threshold crossing.

12. A method as set forth in claim 1 wherein calculating the ambient heat transfer condition adjacent the shape memory alloy element includes solving an equation relating the measured period of time taken to heat the shape memory alloy element to the pre-determined level of the resistance characteristic to the ambient heat transfer condition of the shape memory alloy element.

13. A method as set forth in claim 1 wherein calculating the ambient heat transfer condition adjacent the shape memory alloy element includes referencing a table relating the measured period of time taken to heat the shape memory alloy element to the pre-determined level of the resistance characteristic to the ambient heat transfer condition of the shape memory alloy element.

14. A method as set forth in claim 1 wherein sensing the resistance of the shape memory alloy element over a period of time includes sensing an inflection point of the resistance to determine the resistance characteristic of the shape memory alloy element.

15. A method of controlling a shape memory alloy element, the method comprising:
heating the shape memory alloy element;
sensing a resistance of the shape memory alloy element over a period of time;
measuring the period of time taken to heat the shape memory alloy element until a resistance characteristic reaches a pre-determined level;
calculating an ambient heat transfer condition adjacent the shape memory alloy element from the measured period of time taken to heat the shape memory alloy element to the pre-determined level of the resistance characteristic; and
adjusting actuation of the shape memory alloy element based upon the calculated ambient heat transfer condition adjacent the shape memory alloy element.

16. A method as set forth in claim 15 wherein adjusting actuation of the shape memory alloy element based upon the calculated heat transfer condition adjacent the shape memory alloy element includes one of adjusting an actuation current for the shape memory alloy element, adjusting a duty cycle of an actuation signal actuating the shape memory alloy element, and adjusting a voltage of an electrical current flowing through the shape memory alloy element.

17. A method as set forth in claim 15 further comprising relating the calculated ambient heat transfer condition adjacent the shape memory alloy element to a heat transfer coefficient between the ambient and the shape memory alloy element.

18. A method as set forth in claim 17 wherein adjusting actuation of the shape memory alloy element based upon the calculated ambient heat transfer condition adjacent the shape memory alloy element is further defined as adjusting actuation of the shape memory alloy element based upon the heat transfer coefficient between the ambient and the shape memory alloy element.

19. A method of sensing an ambient heat transfer condition, the method comprising:
inputting energy into the shape memory alloy element to heat the shape memory alloy element.
sensing a resistance of the shape memory alloy element over a period of time;
measuring an amount of energy taken to heat the shape memory alloy element until a resistance characteristic reaches a pre-determined level; and
calculating an ambient heat transfer condition adjacent the shape memory alloy element from the measured amount of energy taken to heat the shape memory alloy element to the pre-determined level of the resistance characteristic.
